(19) United States
(12) Patent Application Publication
(10) Pub. No.: US 2015/0081387 A1
(43) Pub. Date: Mar. 19, 2015

(54) METHOD AND SYSTEM FOR IDENTIFYING INFLUENCERS FROM PAYMENT DATA

(71) Applicant: MasterCard International Incorporated, PURCHASE, NY (US)

(72) Inventors: Justin Xavier HOWE, Oakdale, NY (US); Kenny Unser, Fairfield, CT (US)

(73) Assignee: MasterCard International Incorporated, PURCHASE, NY (US)

(21) Appl. No.: 14/029,577

(22) Filed: Sep. 17, 2013

(51) Int. Cl. G06Q 30/02

(52) U.S. Cl. CPC G06Q 30/0204
USPC 705/7.33

(57) ABSTRACT

A method for identifying a trendsetting consumer includes: storing transaction entries, each entry including a consumer identifier, transaction date, and transaction characteristics each having a characteristic value; receiving two trend identifiers, each trend identifier including a trend date and transaction characteristic value and is associated with a specific trend; identifying a trending consumer where a first transaction entry includes a transaction date corresponding to the trend date and a transaction characteristics having a characteristic value corresponding to the transaction characteristic value of one of the two identified trends, a second transaction entry includes a transaction date corresponding to the trend date and a transaction characteristics having a characteristic value corresponding to the transaction characteristic value of another one of the two identified trends, and the first and second transaction entries include a common consumer identifier associated with the trending consumer; and associating the trending consumer with the specific trends.

### FIELD

The present disclosure relates to the identification of influential consumers using payment data, specifically identifying consumers who are ahead of commercial trends as trendsetters based on payment transaction data.

### BACKGROUND

Many people and entities closely watch consumer trends. Some consumers pay attention to trends in an effort to do or wear what is considered “hot.” Merchants and manufacturers often keep apprised of trends in order to develop future products, advertise, and reach out to consumers. However, these entities can often not identify a trend until after it has gained significant traction as a trend. As a result, efforts taken to capitalize on the trend may not be as fruitful as they could be if the efforts were taken earlier. Thus, there is a need for a technical solution to provide earlier identification of trends.

Some consumers that are at the forefront of a particular trend may be well-known, such as actors, actresses, and sports figures. However, there may be a number of other consumers that are trendsetters that are not easily identifiable using traditional ways, such as human observation. Identification of these consumers as trendsetters may enable an entity to quickly identify new trends based on the actions of these trendsetting consumers. Thus, there is a further need for a technical solution to provide identification of these trendsetters, in order to achieve earlier identification of trends.

### SUMMARY

The present disclosure provides a description of systems and methods for identifying a trendsetting consumer.

A method for identifying a trendsetting consumer includes: storing, in a database, a plurality of transaction data entries, wherein each transaction data entry includes data related to a payment transaction including at least a consumer identifier, a transaction date, and a plurality of transaction characteristics each having a characteristic value; receiving, by a receiving device, at least two trend identifiers, wherein each trend identifier includes at least a trend date and a transaction characteristic value and is associated with a specific trend; identifying, in the database, at least one trending consumer where a first transaction data entry includes a transaction date corresponding to or before the trend date and one of the plurality of transaction characteristics has a characteristic value corresponding to the transaction characteristic value of one of the at least two identified trends, a second transaction data entry includes a transaction date corresponding to or before the trend date and one of the plurality of transaction characteristics has a characteristic value corresponding to the transaction characteristic value of another one of the at least two identified trends, and the first transaction data entry and the second transaction data entry include a common consumer identifier associated with the respective at least one trending consumer; and associating, by a processing device, the identified at least one trending consumer with the specific trend associated with each of the at least two trend identifiers.

A system for identifying a trendsetting consumer includes a database, a receiving device, and a processing device. The database is configured to store a plurality of transaction data entries, wherein each transaction data entry includes data related to a payment transaction including at least a consumer identifier, a transaction date, and a plurality of transaction characteristics each having a characteristic value. The receiving device is configured to receive at least two trend identifiers, wherein each trend identifier includes at least a trend date and a transaction characteristic value and is associated with a specific trend. The processing device is configured to: identify, in the database, at least one trending consumer where a first transaction data entry includes a transaction date corresponding to or before the trend date and one of the plurality of transaction characteristics has a characteristic value corresponding to the transaction characteristic value of one of the at least two identified trends, a second transaction data entry includes a transaction date corresponding to or before the trend date and one of the plurality of transaction characteristics has a characteristic value corresponding to the transaction characteristic value of another one of the at least two identified trends, and the first transaction data entry and the second transaction data entry include a common consumer identifier associated with the respective at least one trending consumer; and associate the identified at least one trending consumer with the specific trend associated with each of the at least two trend identifiers.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for identifying trendsetting consumers in accordance with exemplary embodiments.

FIG. 2 is a block diagram illustrating the processing server of FIG. 1 for the identification of trendsetting consumers in accordance with exemplary embodiments.

FIG. 3 is a flow diagram illustrating a method for identifying trends associated with a specific consumer in accordance with exemplary embodiments.

FIG. 4 is a flow diagram illustrating a method for identifying consumers associated with specific trends in accordance with exemplary embodiments.

FIG. 5 is a diagram illustrating matching trend data to transaction data in accordance with exemplary embodiments.

FIG. 6 is a flow chart illustrating an exemplary method for identifying a trendsetting consumer in accordance with exemplary embodiments.

FIG. 7 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Definition of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard®, VISA®, Discover®, American Express®, etc.

### System for Identifying Trendsetting Consumers

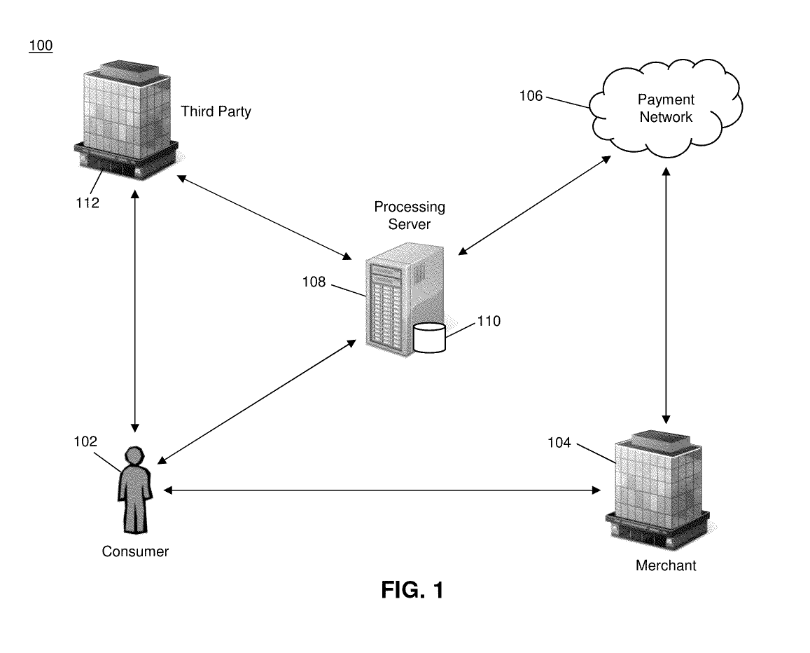

FIG. 1 illustrates a system 100 for identifying trendsetting consumers based on payment transaction data.

The system 100 may include a consumer 102, that may be a trendsetter for consumer trends. The consumer 102 may conduct a payment transaction with a merchant 104 that may be indicative of a trend. As part of the processing of the payment transaction, the merchant 104 (e.g., or an acquirer on behalf of the merchant 104) may generate and submit an authorization request for the transaction to a payment network 106. The payment network 106 may process the payment transaction based on the authorization request using methods and systems that will be apparent to persons having skill in the relevant art.

After processing the payment transaction, the payment network 106 may provide a copy of the transaction data to a processing server 108, discussed in more detail below. The processing server 108 may store the received transaction data in a transaction database 110. The transaction data may include a consumer identifier associated with the consumer 102 and a plurality of transaction characteristics. Each transaction characteristic may have a corresponding characteristic value, and may correspond to one or more pieces of transaction data related to the payment transaction. For example, transaction characteristics may include merchant name, geographic location, geographic municipality, merchant category, product data, product name, product code, merchant brand, product size, and/or transaction amount.

The processing server 108 may then use trend data to identify the consumer 102 as associated with one or more trends based on transaction data corresponding to the consumer 102 and stored in the transaction database 110. The trend data may be entered by users of the processing server 108, or may be received from a third party 112. The trend data may be any data suitable for identifying a specific trend, and may include at least a date and a characteristic value for a transaction characteristic. The processing server 108 may match transaction data to the trend data using methods discussed in more detail below.

Once the processing server 108 has matched a transaction to a trend, the processing server 108 may associate the consumer 102 involved in the transaction with the specific trend. In some embodiments, the consumer 102 may not be considered associated with a trend if the consumer 102 has a prior transaction history matching the trend transaction characteristic value. If the consumer 102 is associated with more than one trend, then the consumer 102 may be considered to be a trendsetter.

The processing server 108 may then identify future transactions involving the trendsetting consumer 102 as potential trends. The third party 112 may request information regarding the consumer 102, which may be provided by the processing server 108 or the consumer 102 based on the permission of the consumer 102. For example, the third party 112 may be a clothing manufacturer that may be interested in recreating trendy fashion designs, which may be identified based on the shopping patterns of the consumer 102. In such an instance, the consumer 102 may not only be a part of previous trends, but may actively influence future trends based on their transaction behavior.

In other instances, the third party 112 may provide the processing server 108 with trend data, and may request information regarding consumers associated with the particular trend. The processing server 108 may identify the consumers 102 associated with the trend based on the trend data, and provide relevant information to the third party 112. It will be apparent to persons having skill in the relevant art that information associated with the consumer 102 may only be provided to the third party 112 with the consent of the consumer 102, or that the third party 112 may only be provided non-personally identifiable information.

### Processing Device

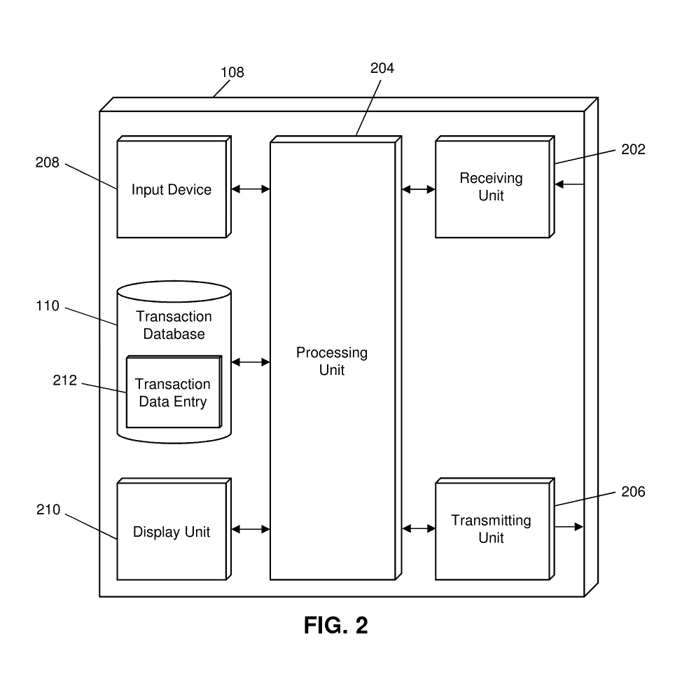

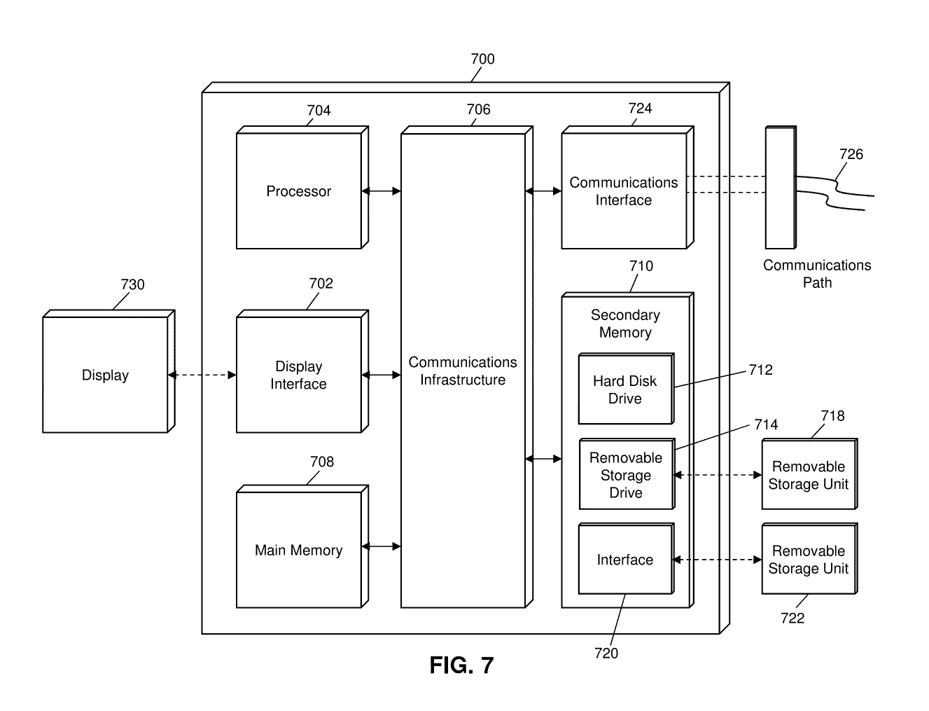

FIG. 2 illustrates an embodiment of the processing server 108 of the system 100. It will be apparent to persons having skill in the relevant art that the embodiment of the processing server 108 illustrated in FIG. 2 is provided as illustration only and may not be exhaustive to all possible configurations of the processing server 108 suitable for performing the functions as discussed herein. For example, the computer system 700 illustrated in FIG. 7 and discussed in more detail below may be a suitable configuration of the processing server 108.

The processing server 108 may include a receiving unit 202. The receiving unit 202 may be configured to receive data from one or more networks via one or more network protocols. The receiving unit 202 may receive transaction data from the payment network related to payment transactions involving a plurality of consumers. The processing server 108 may also include a processing unit 204. The processing unit 204 may be configured to store the transaction data in the transaction database 110 as a plurality of transaction data entries 212.

Each transaction data entry 212 may include at least a consumer identifier, a transaction date, and a plurality of transaction characteristics each having a transaction value. The consumer identifier may be a unique value associated with a particular consumer 102, such as an identification number, username, payment account number, etc. The transaction date may be the date on which the related payment transaction was conducted (e.g., initiated, processed, cleared, etc.). The transaction characteristics, as discussed above, may correspond to data associated with the related payment transaction, such as merchant name, geographic location, geographic municipality, merchant category, product data, product name, product code, merchant brand, product size, and/or transaction amount.

The receiving unit 202 of the processing server 108 may also be configured to receive trend data from a third party 112. The trend data may include at least a trend date and a transaction characteristic value. For example, the trend data may be corresponding to a trend where consumers shopped at a particular merchant. The trend data may thus include a trend date corresponding to the start of the trend and the transaction characteristic value may be the merchant name of the particular merchant. In some embodiments, the trend data may be input into the processing server 108 via an input device 208. The input device 208 may be a keyboard, mouse, touch screen, click wheel, microphone, camera, or other suitable input device that will be apparent to persons having skill in the relevant art.

The processing unit 204 may also be configured to match transaction data entries 212 to trend data. The processing unit 204 may match transaction data entries 212 to trend data by identifying transaction data entries 212 whose transaction date correspond to the trend date and who have a characteristic value that corresponds to the transaction characteristic value included in the trend data. For example, if the trend is for shopping at a particular merchant starting at a particular date, matched transaction data entries may include a transaction date before or close to the particular trend date and may include a merchant name characteristic having the particular merchant as a characteristic value.

Once a transaction data entry 212 has been matched to a trend, the processing unit 204 may associate the consumer 102 involved in the transaction with the trend. In some embodiments, the processing server 108 may include a consumer database. Consumer-trend associations may be stored in the consumer database, such as in a consumer profile associated with the respective consumer. The processing unit 204 may also identify consumers that are associated with more than one trend, and may identify (e.g., in the consumer database) those consumers as trendsetters.

The processing server 108 may also include a transmitting unit 206. The transmitting unit 206 may be configured to transmit data across one or more networks via one or more network protocols. In some embodiments, the transmitting unit 206 may be configured to transmit consumer, transaction, and/or trend data (e.g., to the third party 112). In embodiments where the transmitting unit 206 may transmit consumer data, the processing unit 204 may be configured to remove any personally identifiable information from the consumer data using systems and methods that will be apparent to persons having skill in the relevant art.

In some embodiments, the processing server 108 may also include a display unit 210. The display unit 210 may be configured to display data to a user, such as trend data, transaction data, consumer data, or a combination thereof. The display unit 210 may be any type of display suitable for performing the functions as disclosed herein, such as a liquid crystal display, light emitting diode display, capacitive touch display, etc.

### Methods for Identifying Trendsetting Consumers

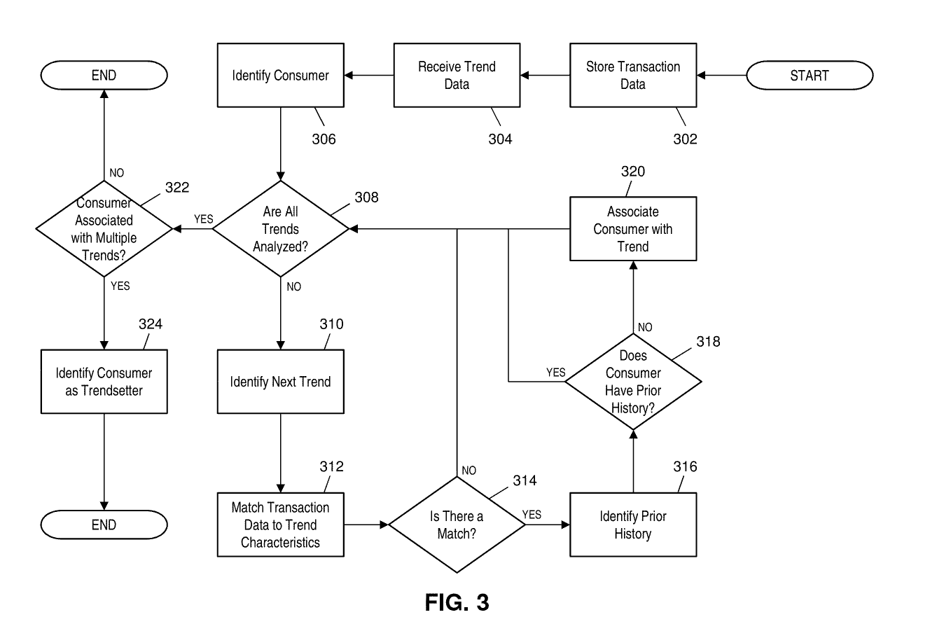

FIG. 3 illustrates a method for identifying trendsetting consumers using the processing server 108.

In step 302, the processing server 108 may store transaction data for a plurality of payment transactions in the transaction database 110 as a plurality of transaction data entries 212. In step 304, the processing server 108 may receive trend data, such as from the third party 112 or via the input device 208. In step 306, the processing server 108 may identify a consumer 102 for whom associated trends are to be identified.

In step 308, the processing server 108 may determine if all potential trends corresponding to the received trend data have been analyzed for association with the consumer 102. If not, then, in step 310, the processing unit 204 of the processing server 108 may identify the next trend to analyze. In step 312, the processing unit 204 may match transaction data for transactions involving the consumer 102 to trend characteristics include in the received trend data for the identified trend. In step 314, the processing unit 204 may determine if there is at least one payment transaction that matches the specific trend. If not, then the process may return to step 308 to determine if more tends are to be analyzed.

If there is a match between the trend and transaction data, then, in step 316, the processing unit 204 may identify any prior transaction history of the consumer 102 with respect to the specific transaction characteristic value associated with the trend. In step 318, the processing unit 204 may determine if any prior transaction history has been identified. If there is no prior history, then, in step 320, the processing unit 204 may associate the consumer 102 with the specific trend. If the consumer 102 has a prior history, then the analysis for the specific trend may be completed. In such an instance, the prior history of the consumer 102 may indicate that the consumer 102 is not participating in the trend as the consumer 102 may have conducted the matching transaction regardless of a current or burgeoning trend.

Once all of the trends have been analyzed, then, in step 322, the processing unit 204 may determine if the consumer 102 has been associated with multiple trends. If the consumer 102 has not, then the process may finish. If the consumer 102 has been associated with multiple trends, then, in step 324, the consumer may be identified as a trendsetter. In such an instance, the processing server 108 may only identify the consumer 102 as a trendsetter if the consumer 102 is associated with multiple trends to eliminate the possibility of the consumer 102 “stumbling upon” a particular trend, or participating in a single trend without normally following trends.

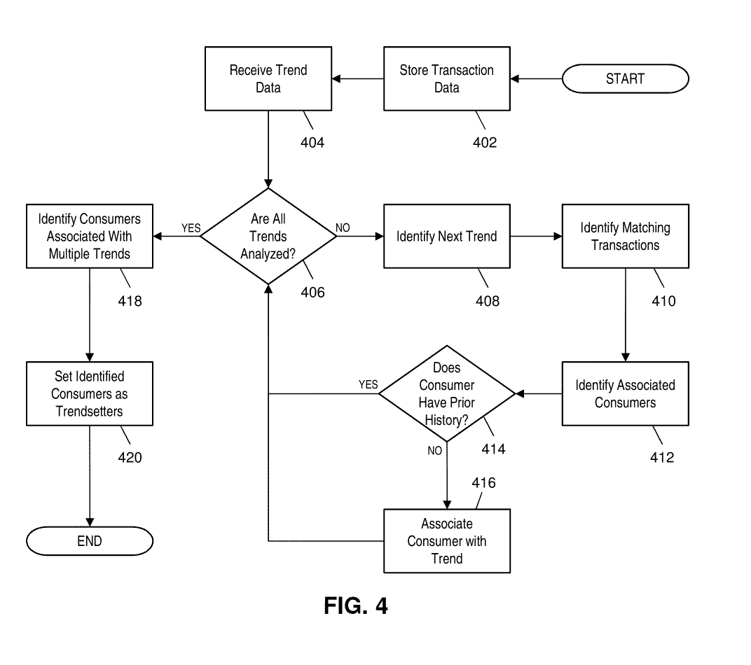

FIG. 4 illustrates an alternative method for identifying consumers as trendsetters based on payment transaction data.

In step 402, the processing server 108 may store transaction data for a plurality of payment transactions involving consumers in the transaction database 110 as a plurality of transaction data entries 212. In step 404, the processing server 108 may receive trend data for one or more trends. In step 406, the processing unit 204 may determine if all trends corresponding to the received trend data have been analyzed. If not all trends have been analyzed, then, in step 408, the processing unit 204 may identify the next trend to be analyzed.

In step 410, the processing unit 204 may match transaction data entries 212 to the trend based on the trend date and transaction characteristic value associated with the specific trend. In step 412, the processing unit 204 may identify consumers 102 that are associated with the matched transaction data entries 212. In step 414, the processing unit 204 may determine, for each identified consumer 102, if the respective identified consumer 102 has a prior transaction history corresponding to the transaction characteristic value.

If the consumer 102 does not have a prior transaction history, then, in step 416, the consumer 102 may be associated with the specific trend. If the consumer 102 has a prior transaction history, then the consumer 102 may not be associated with the trend. Once all of the trends have been analyzed, the processing unit 204 may identify all consumers 102 associated with multiple trends, in step 418. Then, in step 420, the processing unit 204 may set each of the identified consumers 102 as a trendsetter.

FIGS. 3 and 4 illustrate methods for identifying trendsetting consumers, by identifying a consumer and matching the specific consumer to trends, or, alternatively, by identifying trends and then finding consumers that match to those specific trends. In either instance, the processing server 108 may be configured to identify consumers that are trendsetters. In such an instance, the processing server 108 may be able to quickly and effectively identify trendsetting consumers, including consumers that may be unknown as trendsetters using traditional systems and methods. In addition, it may enable the processing server 108 to identify trends before or as they become trends by following the purchase habits of known trendsetters.

### Matching Trend Data to Transaction Data

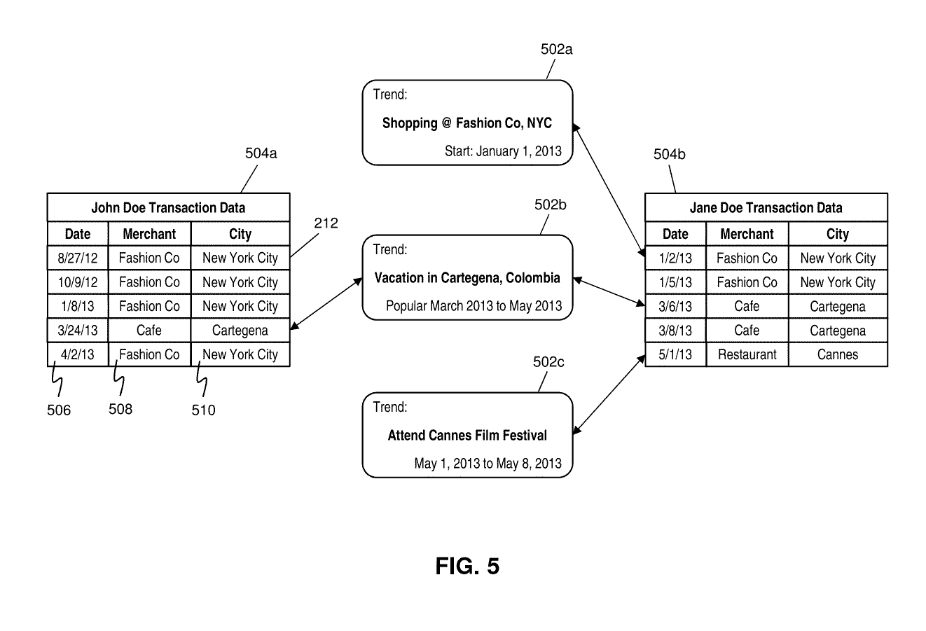

FIG. 5 illustrates the matching of transaction data for payment transactions to trend data.

The processing unit 204 of the processing server 108 may be configured to match trend data 502 corresponding to multiple trends, illustrated in FIG. 5 as trend data 502a, 502b, and 502c. Each trend data 502 may include at least a trend date and a transaction characteristic value. In some instances, the trend data may be a start date, a specific date range, or a fluid date range. For example, as illustrated in FIG. 5, trend data 502a may correspond to a trend of shopping at Fashion Co in New York City, which became popular from Jan. 1, 2013. Trend data 502b may correspond to a trend of vacationing in Cartagena, Colombia, which was popular between March and May of 2013. Trend data 502c may correspond to a trend of attending the Cannes Film Festival, which occurred between May 1 and May 8 of 2013.

The processing unit 204 may identify transaction data entries 212 for consumers 102 for whom associated trends are to be identified. As illustrated in FIG. 5, the processing unit 204 may identify a first subset of transaction data entries 504a corresponding to a first consumer 102, John Doe, and a second subset of transaction data entries 504b corresponding to a second consumer 102, Jane Doe. The processing unit 204 may then match the transaction data entries 212 in each of the subsets 504a and 504b with the trend data 502 using transaction dates 506 and transaction characteristics, such as merchant name 508 and merchant city 510.

For example, the subset 504a associated with John Doe may be matched to a single trend, trend 502b. As illustrated in FIG. 5, John Doe may have transacted in Cartagena, Colombia during the time at which vacationing in Cartagena was popular. Accordingly, the transaction may be matched to trend 502b, and John Doe may thereby be associated with the trend. Although John Doe also transacted at Fashion Co in New York City after Jan. 1, 2013, because John Doe regularly shops at Fashion Co (e.g., and thus has a prior history), John Doe may not be considered to be associated with the trend and may instead simply be a normal regular customer at Fashion Co.

As a result, John Doe may only be associated with the trend 502b of vacationing in Cartagena. As John Doe is only associated with a single trend, John Doe may, in some instances, not be considered a trendsetter. On the other hand, Jane Doe may be considered a trendsetter as she may be associated with all three trends 502a, 502b, and 502c. As illustrated in FIG. 5, Jane Doe has a transaction history in the subset 504b including transactions at Fashion Co after Jan. 1, 2013, transactions in Cartagena during the March to May 2013 period, and transactions in Cannes during the Cannes Film Festival. Jane Doe may thus be associated with each of the trends, and thereby considered a trendsetter.

### Method for Identifying a Trendsetting Consumer

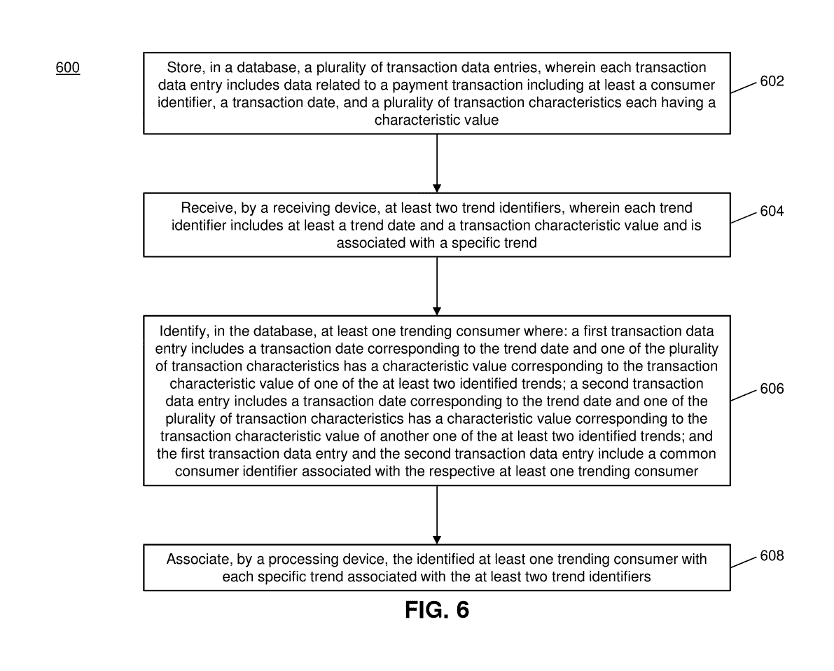

FIG. 6 illustrates a method 600 for identifying a trendsetting consumer.

In step 602, a plurality of transaction data entries (e.g., transaction data entries 212) may be stored in a database (e.g., the transaction database 110), wherein each transaction data entry 212 includes data related to a payment transaction including at least a consumer identifier, a transaction date, and a plurality of transaction characteristics each having a characteristic value. In some embodiments, the plurality of transaction characteristics may include at least one of: merchant name, geographic location, geographic municipality, merchant category, product data, product name, product code, merchant brand, product size, and transaction amount.

In step 604, a receiving device (e.g., the receiving unit 202 or the input device 208) may receive at least two trend identifiers, wherein each trend identifier includes at least a trend date and a transaction characteristic value and is associated with a specific trend.

In step 606, at least one trending consumer (e.g., the consumer 102) may be identified where: a first transaction data entry 212 includes a transaction date corresponding to or before the trend date and one of the plurality of transactions characteristics has a characteristic value corresponding to the transaction characteristic value of one of the at least two identified trends; a second transaction data entry includes a transaction date corresponding to the trend date and one of the plurality of transaction characteristics has a characteristic value corresponding to the transaction characteristic value of another one of the at least two identified trends; and the first transaction data entry and the second transaction data entry include a common consumer identifier associated with the respective at least one trending consumer. In one embodiment, the transaction characteristic value for a first of the at least two trend identifiers may be a specific merchant (e.g., the merchant 104), and the at least one trending consumer may not have a history of payment transactions with the specific merchant 104.

In step 608, a processing device (e.g., the processing unit 204) may associate the identified at least one trending consumer with each specific trend associated with the at least two trend identifiers. In one embodiment, the at least one trending consumer may be identified as a trendsetter. In a further embodiment, the method 600 may further include: receiving, by the receiving device 202, transaction data for a payment transaction including at least the consumer identifier corresponding to the at least one trending consumer identified as a trendsetter and a merchant identifier; and identifying, by the processing device 204, a merchant associated with the merchant identifier included in the transaction data as a new trend.

In some embodiments, if more than a predetermined number of trending consumers is identified, then the method 600 may further include identifying, by the processing device 204, the predetermined number of trending consumers of the identified at least one consumer based on the transaction date included in each of the respective first and second transaction data entries. In such an instance, the processing server 108 may limit the identification of an overwhelming or diluted number of trending consumers, and may identify the earliest trendsetters up to the specific predetermined number.

In another embodiment, the method 600 may further include: receiving, by the receiving device 202, a request for trending consumers, wherein the request for trending consumers includes one of the at least two trend identifiers; and transmitting, by a transmitting device (e.g., the transmitting unit 206), the identified at least one trending consumer associated with the specific trend associated with the one of the at least two trend identifiers. In some embodiments, the method 600 may further include transmitting, by the transmitting device 206, a notification to the identified at least one trending consumer, indicating the association with the specific trend associated with each of the at least two trend identifiers. In another embodiment, the method 600 may further include identifying, by the processing device 204, an audience of consumers identified as trendsetters including at least the identified at least one trending consumer associated with the specific trend associated with each of the at least two trend identifiers.

### Computer System Architecture

FIG. 7 illustrates a computer system 700 in which embodiments of the present disclosure, or portions thereof, may be implemented as computer-readable code. For example, the processing server 108 of FIG. 1 may be implemented in the computer system 700 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3, 4, and 6.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 718, a removable storage unit 722, and a hard disk installed in hard disk drive 712.

Various embodiments of the present disclosure are described in terms of this example computer system 700. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 704 may be a special purpose or a general purpose processor device. The processor device 704 may be connected to a communication infrastructure 706, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 700 may also include a main memory 708 (e.g., random access memory, read-only memory, etc.), and may also include a secondary memory 710. The secondary memory 710 may include the hard disk drive 712 and a removable storage drive 714, such as a floppy disk drive, a magnetic tape drive, an optical disk drive, a flash memory, etc.

The removable storage drive 714 may read from and/or write to the removable storage unit 718 in a well-known manner. The removable storage unit 718 may include a removable storage media that may be read by and written to by the removable storage drive 714. For example, if the removable storage drive 714 is a floppy disk drive, the removable storage unit 718 may be a floppy disk. In one embodiment, the removable storage unit 718 may be non-transitory computer readable recording media.

In some embodiments, the secondary memory 710 may include alternative means for allowing computer programs or other instructions to be loaded into the computer system 700, for example, the removable storage unit 722 and an interface 720. Examples of such means may include a program cartridge and cartridge interface (e.g., as found in video game systems), a removable memory chip (e.g., EEPROM, PROM, etc.) and associated socket, and other removable storage units 722 and interfaces 720 as will be apparent to persons having skill in the relevant art.

Data stored in the computer system 700 (e.g., in the main memory 708 and/or the secondary memory 710) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 700 may also include a communications interface 724. The communications interface 724 may be configured to allow software and data to be transferred between the computer system 700 and external devices. Exemplary communications interfaces 724 may include a modem, a network interface (e.g., an Ethernet card), a communications port, a PCMCIA slot and card, etc. Software and data transferred via the communications interface 724 may be in the form of signals, which may be electronic, electromagnetic, optical, or other signals as will be apparent to persons having skill in the relevant art. The signals may travel via a communications path 726, which may be configured to carry the signals and may be implemented using wire, cable, fiber optics, a phone line, a cellular phone link, a radio frequency link, etc.

Computer program medium and computer usable medium may refer to memories, such as the main memory 708 and secondary memory 710, which may be memory semiconductors (e.g., DRAMs, etc.). These computer program products may be means for providing software to the computer system 700. Computer programs (e.g., computer control logic) may be stored in the main memory 708 and/or the secondary memory 710. Computer programs may also be received via the communications interface 724. Such computer programs, when executed, may enable computer system 700 to implement the present methods as discussed herein. In particular, the computer programs, when executed, may enable processor device 704 to implement the methods illustrated by FIGS. 3, 4, and 6, as discussed herein. Accordingly, such computer programs may represent controllers of the computer system 700. Where the present disclosure is implemented using software, the software may be stored in a computer program product and loaded into the computer system 700 using the removable storage drive 714, interface 720, and hard disk drive 712, or communications interface 724.

Techniques consistent with the present disclosure provide, among other features, systems and methods for providing characteristic payments data. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for identifying a trendsetting consumer, comprising:
storing, in a database, a plurality of transaction data entries, wherein each transaction data entry includes data related to a payment transaction including at least a consumer identifier, a transaction date, and a plurality of transaction characteristics each having a characteristic value;
receiving, by a receiving device, at least two trend identifiers, wherein each trend identifier includes at least a trend date and a transaction characteristic value and is associated with a specific trend;
identifying, in the database, at least one trending consumer where
a first transaction data entry includes a transaction date corresponding to or before the trend date and one of the plurality of transaction characteristics has a characteristic value corresponding to the transaction characteristic value of one of the at least two identified trends,
a second transaction data entry includes a transaction date corresponding to or before the trend date and one of the plurality of transaction characteristics has a characteristic value corresponding to the transaction characteristic value of another one of the at least two identified trends, and
the first transaction data entry and the second transaction data entry include a common consumer identifier associated with the respective at least one trending consumer; and
associating, by a processing device, the identified at least one trending consumer with the specific trend associated with each of the at least two trend identifiers.

2. The method of claim 1, wherein the plurality of transaction characteristics includes at least one of: merchant name, geographic location, geographic municipality, merchant category, product data, product name, product code, merchant brand, product size, and transaction amount.

3. The method of claim 1, wherein the transaction characteristic value for a first of the at least two trend identifiers is a specific merchant, and wherein the at least one trending consumer does not have a history of payment transactions with the specific merchant.

4. The method of claim 1, further comprising:
identifying, by the processing device, the at least one trending consumer as a trendsetter.

5. The method of claim 4, further comprising:
receiving, by the receiving device, transaction data for a payment transaction including at least the consumer identifier corresponding to the at least one trending consumer identified as a trendsetter and a merchant identifier; and
identifying, by the processing device, a merchant associated with the merchant identifier included in the transaction data as a new trend.

6. The method of claim 1, further comprising:
receiving, by the receiving device, transaction data for a payment transaction including at least the consumer identifier corresponding to the at least one trending consumer and a merchant identifier; and
identifying, by the processing device, a merchant associated with the merchant identifier included in the transaction data as a new trend.

7. The method of claim 1, wherein, if more than a predetermined number of trending consumers is identified, the method further comprises:
identifying, by the processing device, the predetermined number of trending consumers of the identified at least one consumer based on the transaction date included in each of the respective first and second transaction data entries.

8. The method of claim 1, further comprising:
receiving, by the receiving device, a request for trending consumers, wherein the request for trending consumers includes one of the at least two trend identifiers; and
transmitting, by a transmitting device, the identified at least one trending consumer associated with the specific trend associated with the one of the at least two trend identifiers.

9. The method of claim 1, further comprising:
transmitting, by a transmitting device, a notification to the identified at least one trending consumer, indicating the association with the specific trend associated with each of the at least two trend identifiers.

10. The method of claim 1, further comprising:
identifying, by the processing device, an audience of consumers identified as trendsetters including at least the identified at least one trending consumer associated with the specific trend associated with each of the at least two trend identifiers.

11. A system for identifying a trendsetting consumer, comprising:
a database configured to store a plurality of transaction data entries, wherein each transaction data entry includes data related to a payment transaction including at least a consumer identifier, a transaction date, and a plurality of transaction characteristics each having a characteristic value;
a receiving device configured to receive at least two trend identifiers, wherein each trend identifier includes at least a trend date and a transaction characteristic value and is associated with a specific trend; and
a processing device configured to
identify, in the database, at least one trending consumer where
a first transaction data entry includes a transaction date corresponding to or before the trend date and one of the plurality of transaction characteristics has a characteristic value corresponding to the transaction characteristic value of one of the at least two identified trends,
a second transaction data entry includes a transaction date corresponding to or before the trend date and one of the plurality of transaction characteristics has a characteristic value corresponding to the transaction characteristic value of another one of the at least two identified trends, and
the first transaction data entry and the second transaction data entry include a common consumer identifier associated with the respective at least one trending consumer, and
associate the identified at least one trending consumer with the specific trend associated with each of the at least two trend identifiers.

12. The system of claim 11, wherein the plurality of transaction characteristics includes at least one of: merchant name, geographic location, geographic municipality, merchant category, product data, product name, product code, merchant brand, product size, and transaction amount.

13. The system of claim 11, wherein the transaction characteristic value for a first of the at least two trend identifiers is a specific merchant, and wherein the at least one trending consumer does not have a history of payment transactions with the specific merchant.

14. The system of claim 11, wherein the processing device is further configured to identify the at least one trending consumer as a trendsetter.

15. The system of claim 14, wherein
the receiving device is further configured to receive transaction data for a payment transaction including at least the consumer identifier corresponding to the at least one trending consumer identified as a trendsetter and a merchant identifier, and
the processing device is further configured to identify a merchant associated with the merchant identifier included in the transaction data as a new trend.

16. The system of claim 11, wherein
the receiving device is further configured to receive transaction data for a payment transaction including at least the consumer identifier corresponding to the at least one trending consumer and a merchant identifier, and
the processing device is further configured to identify a merchant associated with the merchant identifier included in the transaction data as a new trend.

17. The system of claim 11, wherein, if more than a predetermined number of trending consumers is identified, the processing device is configured to identify the predetermined number of trending consumers of the identified at least one consumer based on the transaction date included in each of the respective first and second transaction data entries.

18. The system of claim 11, further comprising:
a transmitting device, wherein
the receiving device is further configured to receive a request for trending consumers, wherein the request for trending consumers includes one of the at least two trend identifiers, and
the transmitting device is configured to transmit the identified at least one trending consumer associated with the specific trend associated with the one of the at least two trend identifiers.

19. The system of claim 11, further comprising:
a transmitting device configured to transmit a notification to the identified at least one trending consumer indicating the association with the specific trend associated with each of the at least two trend identifiers.

20. The system of claim 11, wherein the processing device is further configured to identify an audience of consumers identified as trendsetters including at least the identified at least one trending consumer associated with the specific trend associated with each of the at least two trend identifiers.
